(19) United States
(12) Patent Application Publication
(10) Pub. No.: US 2026/0206070 A1
(43) Pub. Date: Jul. 16, 2026

(54) NETWORK COORDINATION TECHNIQUES FOR LOGICAL CHANNEL PRIORITY ADJUSTMENT

(71) Applicant: Apple Inc., Cupertino, CA (US)

(72) Inventors: Ping-Heng Kuo, London (GB); Alexander Sirotkin, Hod Hasharon (IL); Fangli Xu, Beijing (CN); Haijing Hu, Los Gatos, CA (US); Naveen Kumar R. Palle Venkata, San Diego, CA (US); Peng Cheng, Beijing (CN); Ralf Rossbach, Munich (DE); Yuqin Chen, Beijing (CN); Zhibin Wu, Los Altos, CA (US)

(21) Appl. No.: 19/446,906

(22) Filed: Jan. 12, 2026

Related U.S. Application Data
(60) Provisional application No. 63/745,767, filed on Jan. 15, 2025.

(51) Int. Cl. H04W 74/08

(52) U.S. Cl. CPC H04W 74/0875

(57) ABSTRACT

The present disclosure generally relates to coordinating logical channel (LCH) priority adjustment parameters for a split radio bearer. One aspect of the present disclosure relates to a method including: receiving at least one message that comprises information pertaining to a first remaining time threshold and a second remaining time threshold configured for logical channel priority adjustment triggering, and submitting, based at least on the information, one or more packets to at least one of a first logical entity associated with a first access node or a second logical entity associated with a second access node. The first remaining time threshold is applicable to a first logical channel associated with the first access node and an uplink radio bearer, and the second remaining time threshold is applicable to a second logical channel associated with the second access node and the uplink radio bearer.

### CROSS-REFERENCE TO RELATED APPLICATIONS

This application claims priority to and the benefit of U.S. Provisional Patent Application No. 63/745,767, filed January 15, 2025, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the European Telecommunications Standards Institute (ETSI) Third Generation Partnership Project (3GPP). The wireless communication networks facilitate mobile broadband service using technologies such as Orthogonal Frequency-Division Multiple Access (OFDMA), Multiple Input Multiple Output (MIMO), advanced channel coding, massive MIMO, beamforming, and/or other features.

### SUMMARY

One aspect of the present disclosure relates to a method including: transmitting a first message that includes information pertaining to a remaining time threshold configured for logical channel (LCH) priority adjustment triggering, where the remaining time threshold is applicable to at least one of (i) a first LCH associated with a first access node and an uplink radio bearer or (ii) a second LCH associated with a second access node and the uplink radio bearer; and receiving a second message that includes additional information pertaining to the remaining time threshold.

In some implementations, the first message indicates the remaining time threshold the first access node intends to configure for the first LCH.

In some implementations, the first message indicates a request for the second access node to configure the remaining time threshold for the second LCH.

In some implementations, the first message indicates whether the second access node is to configure any remaining time thresholds for the second LCH.

In some implementations, the second message indicates whether the second access node has accepted the remaining time threshold requested by the first access node.

In some implementations, the second message indicates whether the second access node has configured any remaining time thresholds for the second LCH.

In some implementations, the second message indicates the remaining time threshold the second access node intends to configure for the second LCH.

In some implementations, the second message includes a request for the first access node to configure the remaining time threshold for the first LCH.

In some implementations, the first message configures a user equipment (UE) with the remaining time threshold for the first LCH.

In some implementations, the first message activates or deactivates priority adjustment for the first LCH.

In some implementations, the first message indicates that priority adjustment has been activated or deactivated for the first LCH.

In some implementations, the second message indicates that priority adjustment has been activated or deactivated for the second LCH.

In some implementations, the first message indicates a request for the second access node to activate or deactivate priority adjustment for the second LCH.

In some implementations, the second message indicates whether the second access node has accepted the request to activate or deactivate priority adjustment for the second LCH.

In some implementations, the second message indicates a request for the first access node to activate or deactivate priority adjustment for the first LCH.

In some implementations, the method further includes transmitting a third message that indicates whether the first access node has accepted the request to activate or deactivate priority adjustment for the first LCH.

In some implementations, the first message includes a dynamic indication to change the remaining time threshold for the first LCH.

In some implementations, the first message indicates that the remaining time threshold for the first LCH has been changed to a first value.

In some implementations, the second message indicates that the remaining time threshold for the second LCH has been changed to a new value.

In some implementations, the first message indicates a request for the second access node to refrain from changing the remaining time threshold for the second LCH.

In some implementations, the first message indicates a request for the second access node to change the remaining time threshold for the second LCH to a new value.

In some implementations, the second message indicates whether the request was accepted by the second access node.

In some implementations, the second message indicates a request for the first access node to refrain from changing the remaining time threshold for the first LCH.

In some implementations, the second message indicates a request for the first access node to change the remaining time threshold for the first LCH to a value.

In some implementations, LCH priority adjustment is configured for at most one LCH associated with the uplink radio bearer.

In some implementations, LCH priority adjustment is prohibited for all LCHs associated with the uplink radio bearer.

In some implementations, the remaining time threshold is configured for both the first LCH and the second LCH.

Another aspect of the present disclosure relates to a method including: receiving a first message that includes information pertaining to a remaining time threshold configured for LCH priority adjustment triggering, where the remaining time threshold is applicable to at least one of (i) a first LCH associated with a first access node and an uplink radio bearer or (ii) a second LCH associated with a second access node and the uplink radio bearer; and transmitting a second message that includes additional information pertaining to the remaining time threshold.

Another aspect of the present disclosure relates to one or more processors configured to, when executing instructions stored in a memory, perform any of the foregoing operations.

Another aspect of the present disclosure relates to an access node with one or more processors configured to perform any of the foregoing operations.

Another aspect of the present disclosure relates to a method including: receiving at least one message that includes information pertaining to a first remaining time threshold and a second remaining time threshold configured for LCH priority adjustment triggering, where (i) the first remaining time threshold is applicable to a first LCH associated with a first access node and an uplink radio bearer and (ii) the second remaining time threshold is applicable to a second LCH associated with a second access node and the uplink radio bearer and submitting, based at least on the information, one or more packets to at least one of a first logical entity associated with the first access node or a second logical entity associated with the second access node.

In some implementations, submitting the one or more packets to the at least one of the first logical entity or the second logical entity includes submitting the one or more packets to the first logical entity and refraining from submitting any packets to the second logical entity. LCH priority adjustment triggering is activated for the first LCH and is deactivated for the second LCH.

In some implementations, each of the one or more packets has a remaining time value equal to or less than the first remaining time threshold.

In some implementations, submitting the one or more packets to the at least one of the first logical entity or the second logical entity includes applying a special data volume threshold to determine whether packet submission to the first logical entity is allowed and submitting, based on the special data volume threshold being satisfied, the one or more packets to the first and second logical entities. LCH priority adjustment triggering is activated for the first LCH and is deactivated for the second LCH. The at least one message indicates the special data volume threshold. The special data volume threshold is smaller than a default uplink data split threshold.

In some implementations, submitting the one or more packets to the at least one of the first logical entity or the second logical entity includes determining that a total data volume is larger than a default uplink data split threshold and submitting the one or more packets to the first and second logical entities based at least on a data volume split ratio. LCH priority adjustment triggering is activated for the first LCH and is deactivated for the second LCH. The at least one message indicates the data volume split ratio. The data volume split ratio represents a ratio of distributed packet volume between the first logical entity and the second logical entity.

In some implementations, the at least one message includes a dynamic indication to change the first remaining time threshold configured for the first LCH or the second remaining time threshold configured for the second LCH. The dynamic indication includes an identifier of the first LCH or the second LCH, and a value to use for the first remaining time threshold or the second remaining time threshold.

In some implementations, the value of the first remaining time threshold or the second remaining time threshold is selected from a set of remaining time threshold values configured for the first LCH or the second LCH.

In some implementations, the method further includes disabling priority adjustment for the first LCH based on the value of the first remaining time threshold representing a disablement of priority adjustment for the first LCH, or disabling priority adjustment for the second LCH based on the value of the second remaining time threshold representing a disablement of priority adjustment for the second LCH.

In some implementations, the first remaining time threshold is different from the second remaining time threshold.

In some implementations, the method further includes triggering priority adjustment for at least one of the first LCH or the second LCH based on at least one of (i) a lowest remaining time threshold configured for the first LCH or the second LCH, (ii) a highest remaining time threshold configured for the first LCH or the second LCH, (iii) the first remaining time threshold configured for the first LCH, or (iv) the second remaining time threshold configured for the second LCH.

In some implementations, the method further includes receiving a dynamic instruction to switch the first remaining time threshold.

In some implementations, the method further includes: in response to receiving the dynamic instruction, switching the first remaining time threshold.

In some implementations, the method further includes receiving a dynamic instruction to activate or deactivate LCH priority adjustment for the uplink radio bearer associated with the first LCH and the second LCH.

In some implementations, the method further includes: based on determining that the dynamic instruction is received from the first access node, activating or deactivating LCH priority adjustment for the first LCH, or based on determining that the dynamic instruction is not received from the second access node, activating or deactivating LCH priority adjustment for the second LCH.

In some implementations, the method further includes: in response to receiving the dynamic instruction from at least one of the first access node or the second access node, activating or deactivating LCH priority adjustment for both the first LCH and the second LCH of the uplink radio bearer.

Another aspect of the present disclosure relates to a method including: receiving at least one message that includes a dynamic instruction to switch a remaining time threshold configured for an uplink radio bearer, where the remaining time threshold is applicable to (i) a first LCH associated with a first access node and the uplink radio bearer and (ii) a second LCH associated with a second access node and the uplink radio bearer.

In some implementations, the method further includes switching the remaining time threshold configured for the uplink radio bearer after receiving the dynamic instruction from at least one of the first access node or the second access node.

In some implementations, the method further includes switching the remaining time threshold configured for the uplink radio bearer after receiving the dynamic instruction from the first access node and the second access node within a time period.

Another aspect of the present disclosure relates to a method including: receiving at least one message that includes a dynamic instruction to activate or de-activate LCH priority adjustment for an uplink radio bearer with (i) a first LCH associated with a first access node and the uplink radio bearer and (ii) a second LCH associated with a second access node and the uplink radio bearer.

In some implementations, the method further includes activating or deactivating LCH priority adjustment for at least one of the first LCH and the second LCH of the uplink radio bearer after receiving the dynamic instruction from at least one of the first access node or the second access node.

In some implementations, the method further includes activating or deactivating LCH priority adjustment for only the first LCH or only the second LCH of the uplink radio bearer, based on whether the dynamic instruction is received from the first access node or the second access node.

In some implementations, the method further includes activating or deactivating LCH priority adjustment for both the first LCH and the second LCH of the uplink radio bearer after receiving the dynamic instruction from at least one of the first access node or the second access node.

Another aspect of the present disclosure relates to a baseband processor configured to, when executing instructions stored in a memory, perform operations including: identifying at least one message that comprises information pertaining to a first remaining time threshold and a second remaining time threshold configured for LCH priority adjustment triggering, where (i) the first remaining time threshold is applicable to a first LCH associated with a first access node and an uplink radio bearer and (ii) the second remaining time threshold is applicable to a second LCH associated with a second access node and the uplink radio bearer and causing, based at least on the information, a submission of one or more packets to at least one of a first logical entity associated with the first access node or a second logical entity associated with the second access node.

In some implementations, causing the submission of the one or more packets to the at least one of the first logical entity or the second logical entity includes causing the submission of the one or more packets to the first logical entity and refraining from submitting any packets to the second logical entity. LCH priority adjustment triggering is activated for the first LCH and is deactivated for the second LCH.

In some implementations, each of the one or more packets has a remaining time value equal to or less than the first remaining time threshold.

In some implementations, causing the submission of the one or more packets to the at least one of the first logical entity or the second logical entity includes applying a special data volume threshold to determine whether packet submission to the first logical entity is allowed and causing, based on the special data volume threshold being satisfied, the submission of the one or more packets to the first and second logical entities. LCH priority adjustment triggering is activated for the first LCH and is deactivated for the second LCH. The at least one message indicates the special data volume threshold. The special data volume threshold is smaller than a default uplink data split threshold.

In some implementations, causing the submission of the one or more packets to the at least one of the first logical entity or the second logical entity includes determining that a total data volume is larger than a default uplink data split threshold and causing the submission of the one or more packets to the first and second logical entities based at least on a data volume split ratio. LCH priority adjustment triggering is activated for the first LCH and is deactivated for the second LCH. The at least one message indicates the data volume split ratio. The data volume split ratio represents a ratio of distributed packet volume between the first logical entity and the second logical entity.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example logical channel (LCH) priority switching scheme, according to some implementations.

FIG. 3 illustrates an example packet duplication scheme, according to some implementations.

FIGS. 4 and 5 illustrate process flows of example methods for LCH priority adjustment, according to some implementations.

FIG. 6 illustrates a flowchart of an example process for LCH priority adjustment, according to some implementations.

FIG. 7 illustrates a process flow of another example method for LCH priority adjustment, according to some implementations.

FIGS. 8-10 illustrate flowcharts of example methods for LCH priority adjustment, according to some implementations.

FIG. 11 illustrates an example User Equipment (UE), according to some implementations.

FIG. 12 illustrates an example access node, according to some implementations

### DETAILED DESCRIPTION

In some wireless communication schemes, a logical channel (LCH) may be associated with two priority values, both of which may be configured by the network. The first priority value may be a default LCH priority, and the second priority value may be an alternative LCH or an additional priority. When the remaining time of at least one packet associated with the LCH (e.g., the time until expiry of a discard timer) is equal to or less than a threshold, the UE may be configured to switch the priority of the LCH from the first (default) priority value to the second (alternative) priority value. This LCH priority adaptation can occur before an uplink grant is received to avoid dynamic adaptation during LCH prioritization (LCP). The UE can switch the priority of the LCH back to the first (default) value when the remaining time of all buffered packets associated with the LCH is above the threshold.

In Fifth Generation (5G) New Radio (NR), the packet data convergence protocol (PDCP) entity of a user equipment (UE) may be associated with multiple radio link control (RLC) entities for a split radio bearer. As described herein, a split radio bearer (referred to hereinafter as a split bearer) refers to a radio bearer with data that is distributed or duplicated across multiple logical transport paths (e.g., RLC entities). The PDCP entity of the UE may have one primary RLC entity and at least one secondary RLC entity. With a split bearer, each PDCP PDU can be routed to either the primary or the secondary RLC entity when the uplink data volume of the UE exceeds a threshold (e.g., defined by a parameter like ul-DataSplitThreshold). The two RLC entities associated with the split bearer may correspond to different LCHs in the medium access control (MAC) layer. A data radio bearer (DRB) can also leverage PDCP duplication for dual connectivity, where the PDCP entity is associated with multiple RLC entities (and LCHs) that correspond to different MAC entities.

In some cases, the MAC entities (to which the data is routed) may be affiliated with different base stations (e.g., a master node “MN” and a secondary node “SN”). If the remaining time threshold for LCH priority triggering is configured per LCH, it may be unclear how to configure remaining time thresholds for both LCHs. In particular, configuring a common threshold for both LCHs may be challenging. Furthermore, when LCH priority adjustment is activated on one LCH but not the other (as the base stations may adjust LCH priority independently), the split bearer procedures described above may introduce latency and impact performance.

In accordance with aspects of the present disclosure, a first access node (e.g., an MN or SN) and a second access node (e.g., an SN or MN) may exchange one or more messages to jointly configure and/or adjust a remaining time threshold for LCH priority adjustment triggering. For example, the first access node may transmit a message indicating a remaining time threshold the first access node has configured (or intends to configure) for a first LCH associated with a split bearer or a request for the second access node to use a particular remaining time threshold for a second LCH associated with the split bearer. In response, the second access node can adjust the remaining time threshold configured for the second LCH, request a different remaining time threshold for the first LCH, among other actions. The first access node and the second access node can also exchange various messages (e.g., via an Xn interface) to activate or deactivate LCH priority adjustment for one or both LCHs.

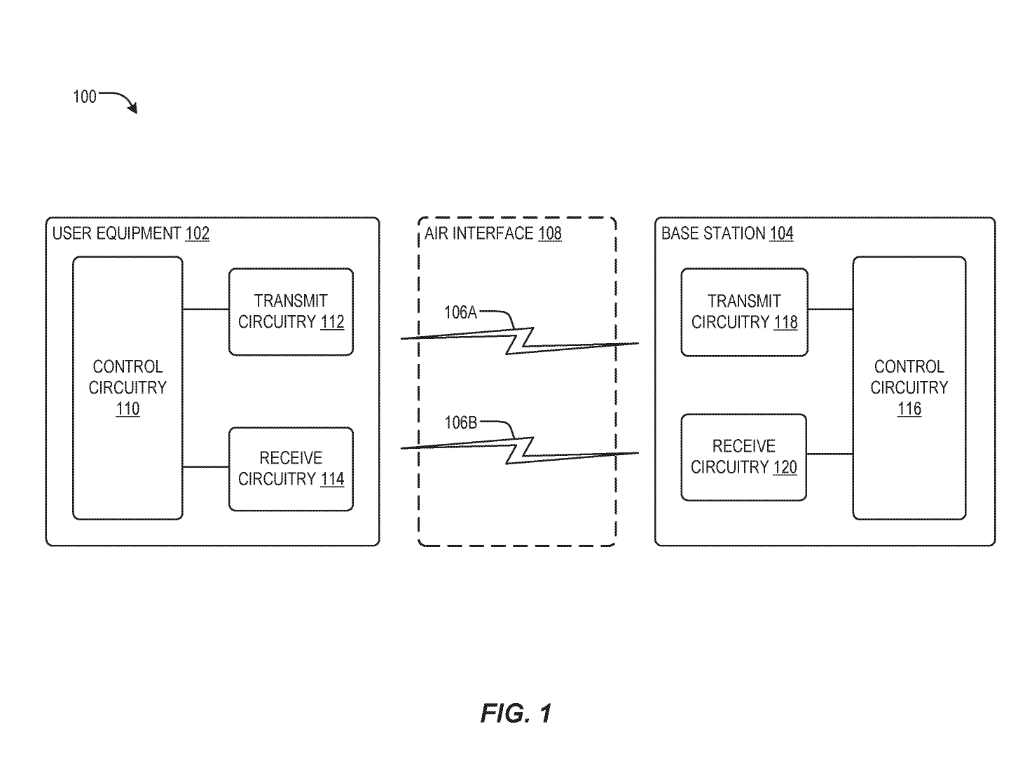

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates 5G NR. In some other implementations, the wireless network 100 is a Non-Standalone (NSA) network that incorporates Long Term Evolution (LTE) and 5G NR. In these implementations, the wireless network 100 may be an Evolved Universal Terrestrial Radio Access (E-UTRA) NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include Radio Frequency (RF) circuitry and/or Front-End Module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE 102. For example, the control circuitry 110 can determine whether to output packets to an RLC entity associated with a MAC entity of the base station 104 based on a data volume threshold configured for LCH priority adjustment triggering.

The transmit circuitry 112 can perform various operations described herein. For example, the transmit circuitry 112 can transmit an indication that the UE 102 has configured or adjusted a remaining time threshold for a first LCH or a second LCH associated with an uplink split bearer. Additionally, the transmit circuitry 112 may transmit using a plurality of multiplexed uplink physical channels. The plurality of uplink physical channels may be multiplexed, e.g., according to Time Division Multiplexing (TDM) or Frequency Division Multiplexing (FDM), and in some implementations, along with Carrier Aggregation (CA). The transmit circuitry 112 may be configured to receive block data from the control circuitry 110 for transmission on the air interface 108.

The receive circuitry 114 can perform various operations described herein. For example, the receive circuitry 114 can receive a dynamic instruction to activate or deactivate priority adjustment for a first LCH and/or a second LCH associated with an uplink split bearer. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, and the like) structured within data blocks that are carried by the physical channels.

FIG. 1 also illustrates the base station 104. In some implementations, the base station 104 may be a 5G Radio Access Network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink interface and may include one or more LCHs, including but not limited to a Physical Sidelink Control Channel (PSCCH), a Physical Sidelink Discovery Channel (PSDCH), and a Physical Sidelink Broadcast Channel (PSBCH).

In some wireless networks that support LCP adjustments, delay/deadline information is used for uplink scheduling to enable high XR capacity while meeting delay requirements and avoiding protocol data unit (PDU) expiry. Some wireless networks may support LCP enhancements based on buffer delay. For example, delay-aware LCP enhancements can help avoid situations where data with a low remaining time is delayed due to data from other LCHs with no delay-critical data. To override/adjust the priority of an LCH based on delay/deadline information, additional priority values can be configured for LCHs with delay-critical data. An independent per-LCH remaining time threshold can also be introduced for delay-critical priority. Some adaptive LCP mechanisms can be dynamically activated or deactivated. For example, the base station 104 may prefer the UE 102 to deactivate LCH priority adjustment when there is network congestion (as more packets become urgent during congested periods), and resources may not be allocated fairly if LCH priority adjustment is triggered more often.

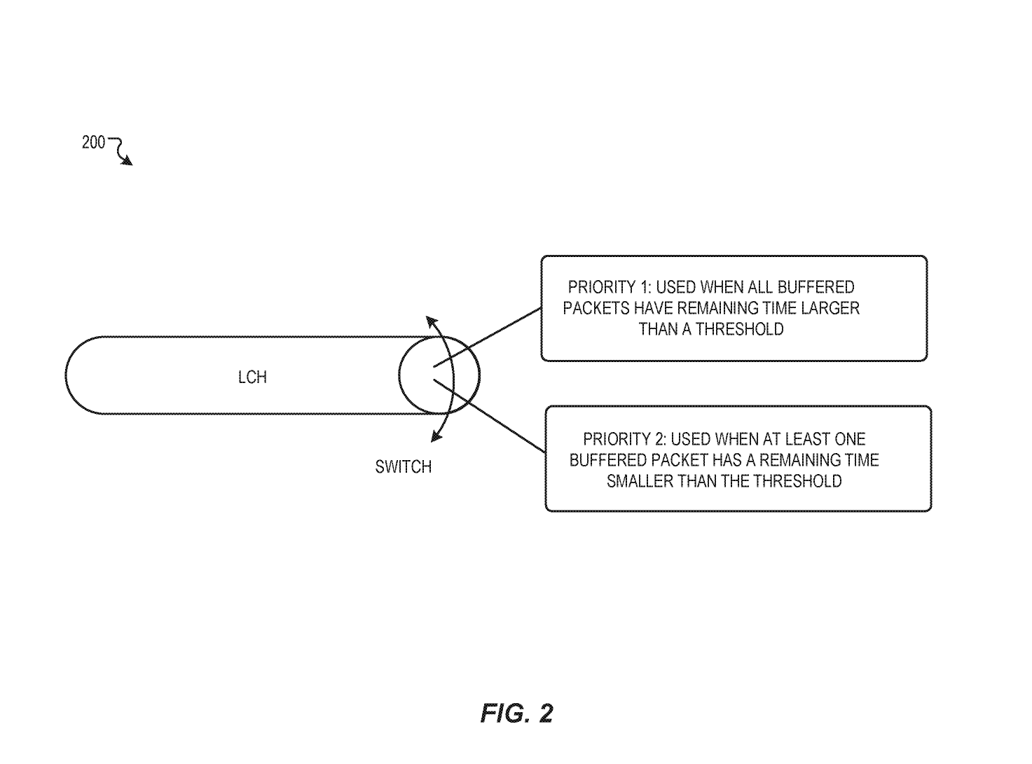

FIG. 2 illustrates an example LCH priority switching scheme 200, according to some implementations. As depicted in FIG. 2, an LCH may be associated with two LCH priorities (Priority #1 and Priority #2), both of which may be configured by the network. The first LCH priority may be a default LCH priority level, and the second LCH priority may be a special/alternative LCH priority level. When the remaining time (e.g., the time until expiry of the discard timer) of at least one packet buffered in the LCH is equal to or less than a threshold, the UE switches the priority of the LCH from the first (default) LCH priority to the second (alternative) LCH priority. This LCH priority adaptation can occur before an uplink grant is received to avoid dynamic adaptation during an LCP procedure (which can increase the complexity of such operations). The UE can switch the priority of the LCH back to the first (default) value when the remaining time of all buffered packets associated with the LCH is above the threshold.

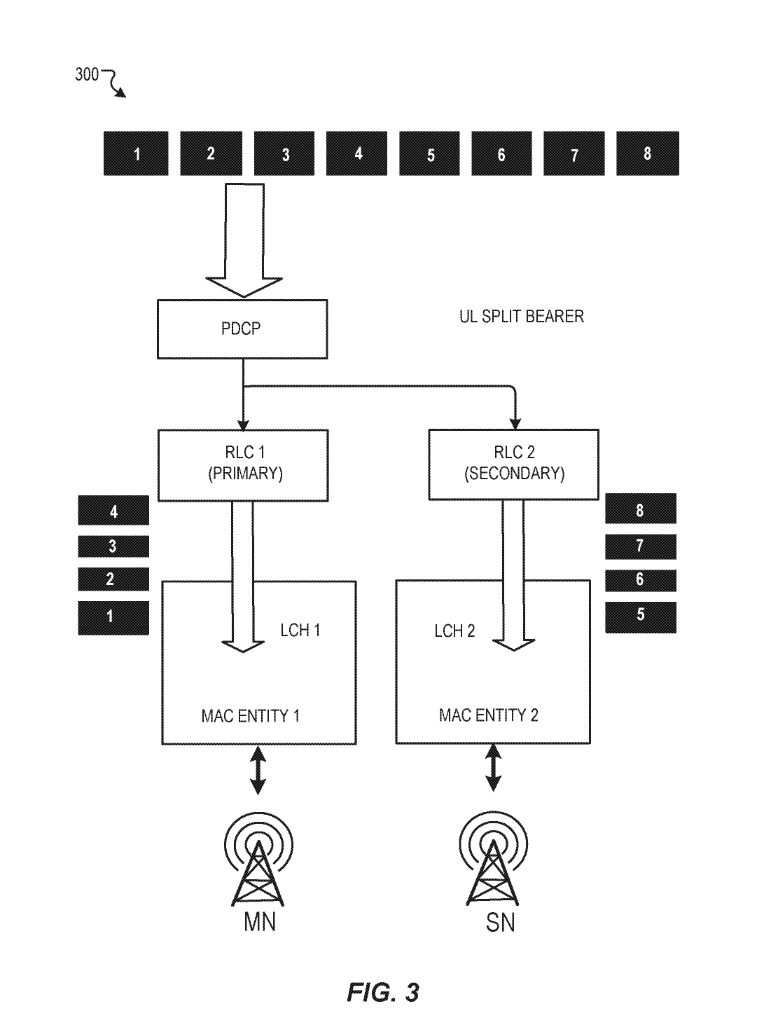

FIG. 3 illustrates an example packet duplication scheme 300, according to some implementations. In 5G NR, a Packet Data Convergence Protocol (PDCP) entity may be associated with multiple RLC entities for a split bearer. In particular, the PDCP entity may have one primary RLC entity and at least one secondary RLC entity. With a split bearer, each PDCP PDU can be submitted to either the primary or the secondary RLC entity when the uplink data volume exceeds a threshold (e.g., ul-DataSplitThreshold). The two RLC entities associated with the split bearer may correspond to different LCHs in the MAC layer.

A data radio bearer (DRB) may also be configured with PDCP duplication in dual connectivity, where the PDCP entity is associated with multiple RLC entities (and hence LCHs) that correspond to different MAC entities. In some cases, these MAC entities are affiliated with different base stations (e.g., a master node “MN” and a secondary node “SN”). If the remaining time threshold for LCH priority triggering is configured per LCH, it may be unclear how to configure remaining time thresholds for both LCHs. For example, it may be desirable to use a common threshold for both LCHs. Furthermore, the dynamic activation/deactivation of LCH priority adjustment behavior for these LCHs may be controlled by different base stations. When LCH priority adjustment is activated on one LCH but not the other (as different base stations may adjust LCH priority independently), the split bearer procedures described above may introduce latency and adversely impact performance.

The techniques described herein generally relate to enabling network coordination for the purpose of configuring remaining time thresholds for LCH priority adjustment in both LCHs of a split bearer. The described techniques can reduce latency and improve performance by leveraging the dynamic nature of LCH priority adjustments for split bearers.

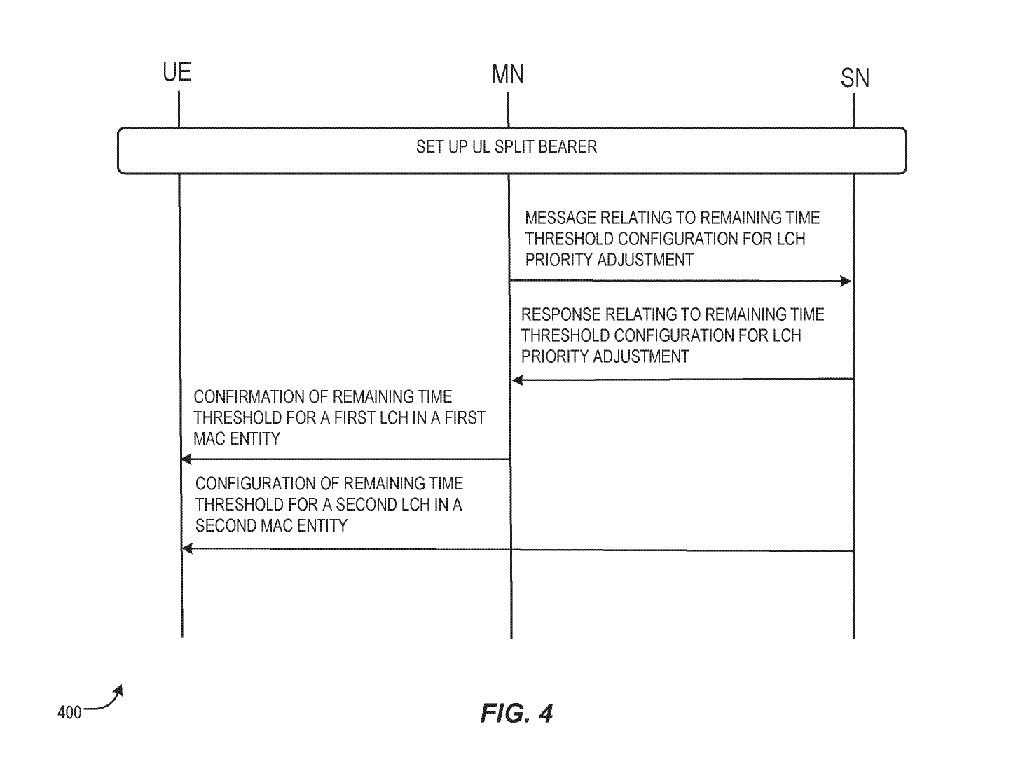

FIG. 4 illustrates a process flow of an example method 400 for LCH priority adjustment, according to some implementations. Some aspects of the method 400 can be implemented by a UE, such as the UE 102 of FIG. 1. Other aspects of the method 400 can be implemented by an MN (e.g., a first access node) and an SN (e.g., a second access node), both of which may be examples of the base station 104 of FIG. 1. In the example method 400, the MN and the SN jointly configure a suitable remaining time threshold for LCP adjustment using the network coordination techniques described herein.

For a split bearer (or PDCP duplication) between the MN and the SN, the MN can send a message (e.g., over an Xn interface) that includes at least one of: an indication of a remaining time threshold for LCH priority adjustment triggering the MN will configure (or has configured) for a first LCH associated with the split bearer; a request/indication of a remaining time threshold for LCH priority adjustment triggering the SN may configure for a second LCH associated with the split bearer; a recommendation/indication of a remaining time threshold for LCH priority adjustment triggering the SN may configure for the second LCH; a request/indication of whether the SN may configure any remaining time threshold(s) for LCH priority adjustment for the second LCH; or a recommendation/indication of whether the SN may configure any remaining time threshold(s) for LCH priority adjustment for the second LCH.

After receiving this message from the MN, the SN may send a response message that includes at least one of: an indication of whether the SN will follow/accept the request/recommendation made by the MN; an indication of whether any remaining time threshold(s) for LCH priority adjustment are configured by the SN for the second LCH; an indication of a remaining time threshold for LCH priority adjustment triggering the SN will configure (or has configured) for the second LCH; or a recommendation/indication of a remaining time threshold for LCH priority adjustment triggering the MN may configure for the first LCH.

This network coordination can be initiated by the SN. For example, the SN may send the MN (e.g., over an Xn interface) a first message including at least one of: an indication of a remaining time threshold for LCH priority adjustment triggering the SN will configure (or has configured) for the second LCH; a request/indication of a remaining time threshold for LCH priority adjustment triggering the MN may configure for the first LCH; a recommendation/request for a remaining time threshold for LCH priority adjustment triggering the MN may configure for the first LCH; an indication of whether the MN may configure any remaining time threshold(s) for LCH priority adjustment for the first LCH; or a recommendation of whether the MN may configure any remaining time threshold(s) for LCH priority adjustment for the first LCH. The MN can respond if the recommendation/request made by the SN is acceptable.

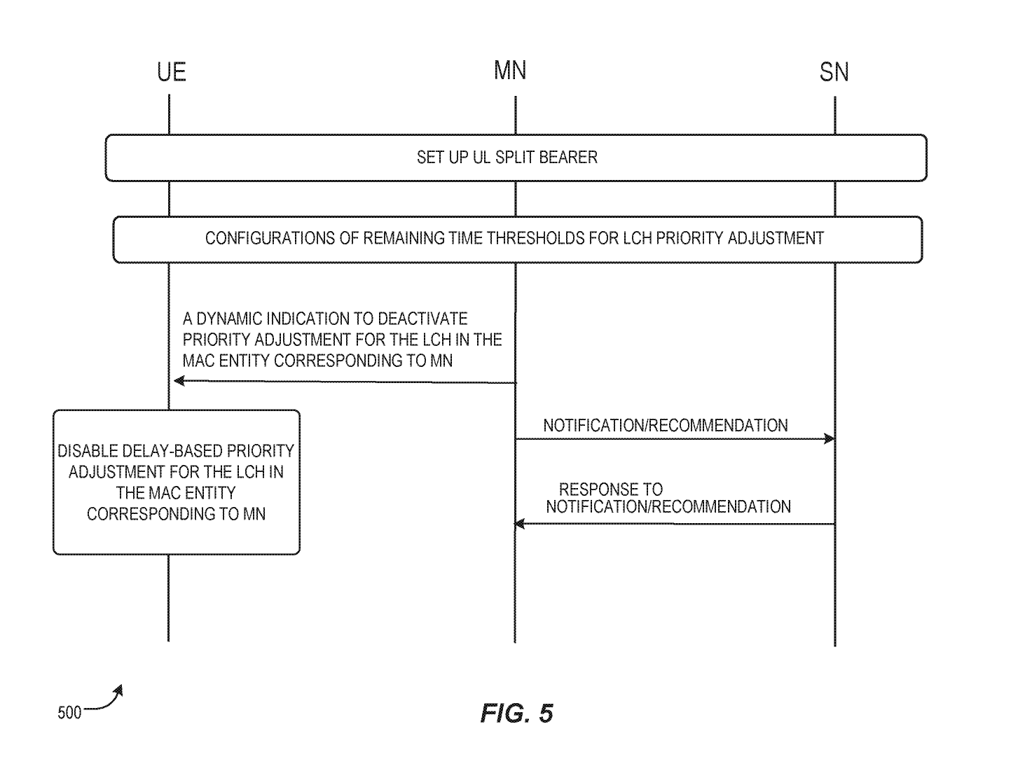

FIG. 5 illustrates a process flow of another example method 500 for LCH priority adjustment, according to some implementations. Some aspects of the method 500 can be implemented by a UE, such as the UE 102 of FIG. 1. Other aspects of the method 500 can be implemented by an MN (e.g., a first access node) and an SN (e.g., a second access node), both of which may be examples of the base station 104 of FIG. 1. In the example method 500, the MN and the SN dynamically activate or deactivate a remaining time threshold for LCP adjustment using the network coordination techniques described herein.

For a split bearer (or PDCP duplication) between the MN and the SN, where both LCHs are configured with a remaining time threshold for LCH priority adjustment, one of the MN or SN may send a dynamic instruction (e.g. via a MAC control element “MAC-CE”, a downlink control information “DCI”, or a PDCP control PDU) to the UE to activate or de-activate LCH priority adjustment for the LCH corresponding to the MAC entity of the MN or the SN. In turn, the MN may send a notification to the SN to indicate that LCH priority adjustment has been activated or de-activated for the LCH corresponding to the MAC entity of the MN. Additionally, or alternatively, the SN may send a notification to the MN (e.g., via an Xn interface) to indicate that LCH priority adjustment has been activated or de-activated for the LCH corresponding to the MAC entity of the SN.

In some implementations, the MN sends a request/recommendation to the SN (e.g., via an Xn interface) to indicate whether LCH priority adjustment can be activated or deactivated for the LCH corresponding to the MAC entity of the SN. For example, the MN may ask the SN to refrain from deactivating LCH priority adjustment until further instructions are received from the MN. In other implementations, the SN sends a request/recommendation to the MN (e.g., via an Xn interface) to indicate whether LCH priority adjustment can be activated for the LCH corresponding to the MAC entity of the SN. Either the MN or the SN can send a response message after receiving any of the foregoing messages. For example, the SN can respond to accept the request (from the MN) to activate or deactivate LCH priority adjustment for the MAC entity of the SN.

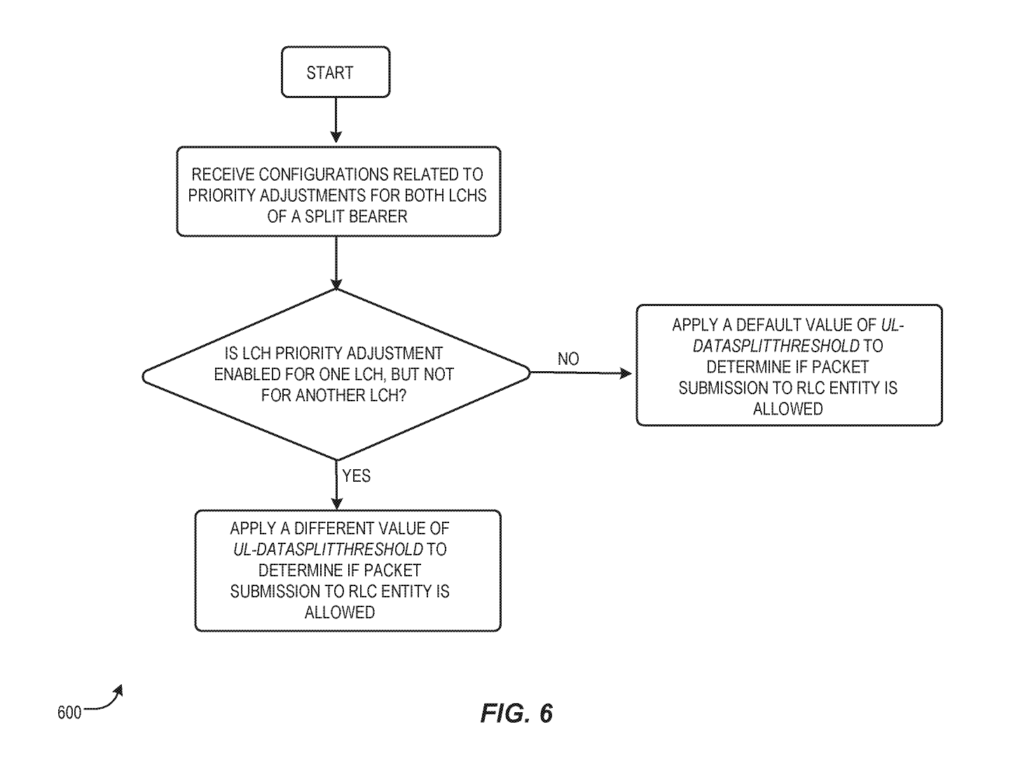

FIG. 6 illustrates a flowchart of an example process 600 for LCH priority adjustment, according to some implementations. Some operations of the process 600 can be performed by a UE, such as the UE 102 of FIG. 1. The example process 600 illustrates UE behavior following dynamic activation or deactivation of a split bearer. In the example process 600, delay-based priority adjustment is de-activated for a first LCH associated with a first MAC entity, while delay-based priority adjustment is activated for a second LCH associated with a second MAC entity.

In some implementations, the PDCP layer of the UE can only submit packet(s) to the RLC entity (or entities) that are associated with the second MAC entity. The PDCP layer of the UE may refrain from submitting packet(s) to RLC entities associated with the first MAC entity. In other implementations, the PDCP layer of the UE may only submit packet(s) with a remaining time equal to or less than a threshold to the RLC entity (or entities) associated with the second MAC entity. The PDCP layer of the UE may refrain from submitting packet(s) with a remaining time smaller than a threshold to RLC entities associated with the first MAC entity.

In some implementations, the PDCP layer of the UE can apply a different data volume threshold when determining if packet submission to the RLC entity (or entities) associated with another MAC entity is allowed. This alternative data volume threshold can be smaller than ul-DataSplitThreshold. If LCH priority adjustment is deactivated for the MN but remains activated for the SN, the UE can apply a lower data volume threshold to allow more packets to be submitted to the RLC entity (or entities) affiliated with the SN. To support this functionality, the PDCP layer of the UE may be configured with two different data volume thresholds.

In some implementations, the PDCP layer of the UE is configured with a split ratio of data volume between two RLC entities. When LCH priority adjustment is deactivated for one LCH, the UE can distribute data across the two RLC entities based on the configured split ratio, if the total data volume is larger than a threshold (e.g., ul-DataSplitThreshold).

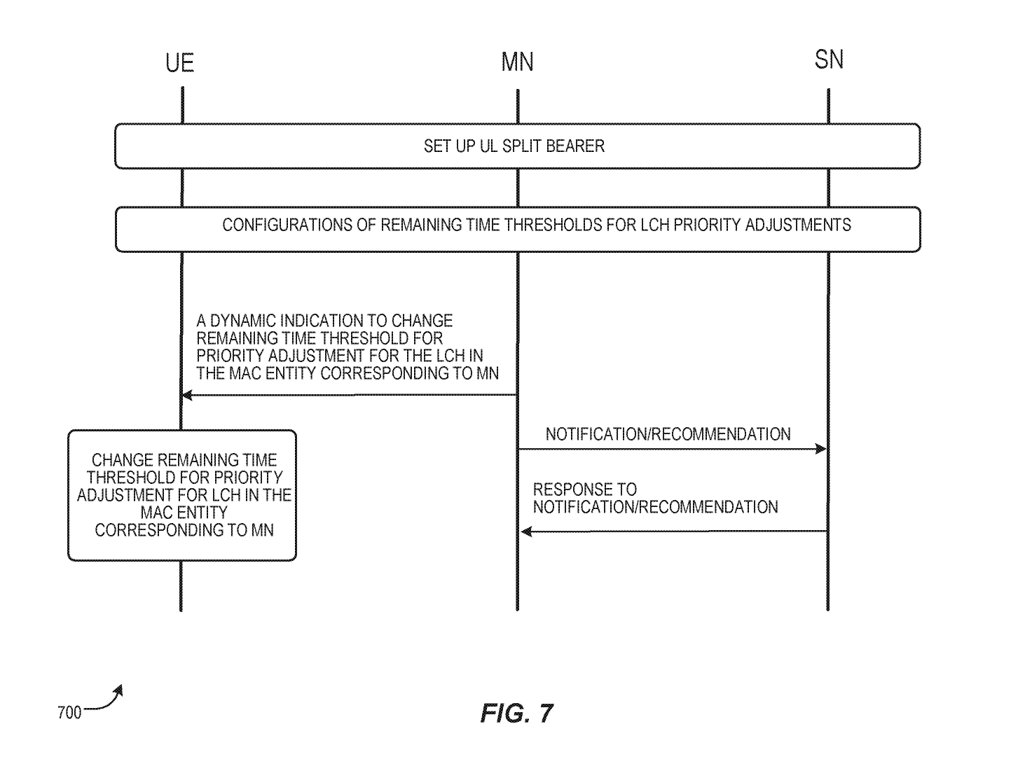

FIG. 7 illustrates a process flow of another example method 700 for LCH priority adjustment, according to some implementations. Some aspects of the method 700 can be implemented by a UE, such as the UE 102 of FIG. 1. Other aspects of the method 700 can be implemented by an MN (e.g., a first access node) and an SN (e.g., a second access node), both of which may be examples of the base station 104 of FIG. 1. In the example method 700, the MN and the SN jointly configure a suitable remaining time threshold for LCP adjustment using the network coordination techniques described herein.

In accordance with some aspects of the present disclosure, the MN and/or the SN can dynamically instruct the UE to change a remaining time threshold for LCH priority adjustment. This dynamic indication can be provided via a MAC-CE that indicates at least one of an identifier of the target LCH(s) or a remaining time threshold value for a particular target LCH (to be applied upon reception of the dynamic indication). The remaining time threshold value can be signaled as an index and/or selected from a set of multiple remaining time threshold values that are pre-configured for the target LCH. In some embodiments, the dynamic indication of the threshold change is provided by means of control signaling that activates or deactivates a particular remaining time threshold. For example, one of the remaining time threshold values may represent “disablement” of LCH priority adjustment. Accordingly, the UE may deactivate priority adjustment for the indicated LCH if such a value is received in the dynamic indication of the threshold change.

The MN or the SN may send a dynamic instruction (e.g., via a MAC-CE) to the UE to change a remaining time threshold for LCH priority adjustment for the LCH corresponding to the MAC entity of the MN or the SN. In some implementations, the MN sends a notification to the SN (e.g., via an Xn interface) to indicate that a remaining time threshold for LCH priority adjustment has changed (and to what value) for the LCH corresponding to the MAC entity of the MN. Additionally, or alternatively, the SN may send a notification to the MN (e.g., via an Xn interface) to indicate that a remaining time threshold for LCH priority adjustment has changed (and to what value) for the LCH corresponding to the MAC entity of the SN.

The MN can send a request/recommendation to the SN (e.g., via an Xn interface) to indicate whether a remaining time threshold for LCH priority adjustment can be changed (and to what value) for the LCH corresponding to the MAC entity of the SN. Likewise, the SN can send a request/recommendation to the MN (e.g., via an Xn interface) to indicate whether a remaining time threshold for LCH priority adjustment can be changed (and to what value) for the LCH corresponding to the MAC entity of the MN. Either the MN or the SN can send a response message after receiving one of the foregoing messages. For example, the SN may respond by accepting the request from the MN to change (or not to change) the remaining time threshold for LCH priority adjustment.

The UE may be configured to handle different remaining time thresholds for LCP adjustment. If, for example, two LCHs are configured with different remaining time thresholds, the UE can employ one or more of the following behaviors when the LCHs have different remaining time thresholds. To trigger LCH priority adjustment for a particular LCH, the UE may determine whether any packet(s) submitted to the corresponding RLC entity has a remaining time less than or equal to the respective remaining time threshold. Alternatively, the UE may trigger LCH priority adjustment for both LCHs based on the smallest or largest remaining time threshold configured for the LCHs. The UE can also trigger LCH priority adjustment for both LCHs based on the remaining time threshold configured for the LCH corresponding to the MN or the SN. In some implementations, the PDCP layer of the UE can apply a different data volume threshold (e.g., different from the default ul-DataSplitThreshold) to determine whether packet submission to an RLC entity associated with another MAC entity is allowed.

In some implementations, the remaining time threshold for LCH priority adjustment is configured per DRB (e.g., at the PDCP layer) instead of per-LCH. This ensures that a common threshold is configured for the two (or more) LCHs, even if they are associated with different base stations. In some implementations, the remaining time threshold is configured per DRB, but the priority adjustment of the two associated LCHs can be activated/deactivated by the corresponding access node (MN or SN). If the MN or the SN sends a dynamic instruction to the UE (e.g., via a MAC-CE or DCI) to switch a remaining time threshold for LCH priority adjustment (or to activate or deactivate LCH priority adjustment), the UE may employ one or more of the following behaviors.

In some implementations, the UE switches the remaining time threshold configured for the DRB whenever such an instruction is received from the MN or the SN. In other implementations, the UE switches the remaining time threshold configured for the DRB only if such an instruction is received from the MN or the SN. Alternatively, the UE may switch the remaining time threshold configured for the DRB only if such an instruction is received from both the MN and the SN with a threshold time period. For example, the UE may start a timer when an instruction is received from one of the base stations (e.g., the MN). The UE will adjust the remaining time threshold as instructed only if the UE receives a corresponding instruction from the other base station (e.g., the SN) before expiry of the timer. In some implementations, the UE can activate/deactivate priority adjustment for both LCHs if a dynamic instruction is received from at least one access node (MN or SN). For example, the UE may activate/deactivate priority adjustment for both LCHs regardless of whether the dynamic instruction is received from the MN or the SN. In other implementations, the UE may activate/deactivate priority adjustment for only the LCH corresponding to the access node from which the dynamic instruction was received. For example, priority adjustment of a first LCH can be activated or deactivated when the UE receives a dynamic instruction from the MN, and priority adjustment of a second LCH can be activated or deactivated when the UE receives a dynamic instruction from the SN. In some implementations, the UE is preconfigured to employ one or more of the foregoing behaviors.

In some embodiments, LCH priority adjustment is configured for at most one of the LCHs associated with a split bearer. In other embodiments, LCH priority adjustment is prohibited for all LCHs associated with the split bearer. In some embodiments, the remaining time threshold for LCH priority adjustment is always configured as the same value for both LCHs associated with the split bearer. For messages exchanged between MN and SN (e.g., over an Xn interface), the information may be sent in an RRC container, such as a container in an S-NODE_MODIFICATION_REQUEST message with the CG-ConfigInfo information element (IE). Alternatively, the information can be sent via a new Xn-AP IE.

If a base station (e.g., the MN and/or the SN) is logically and/or physically separated into a central unit (CU) and a distributed unit (DU), the CU can inform the DU of the initiated/updated/deactivated configuration via an F1 interface. This can be accomplished using an extension of the CG-ConfigInfo IE provided from the CU to the DU in an RRC message. The configuration can be distributed via a UE CONTEXT SETUP REQUEST message or a UE CONTEXT MODIFICATION REQUEST message. Alternatively, the information can be sent in an RRC container or a new F1-AP IE.

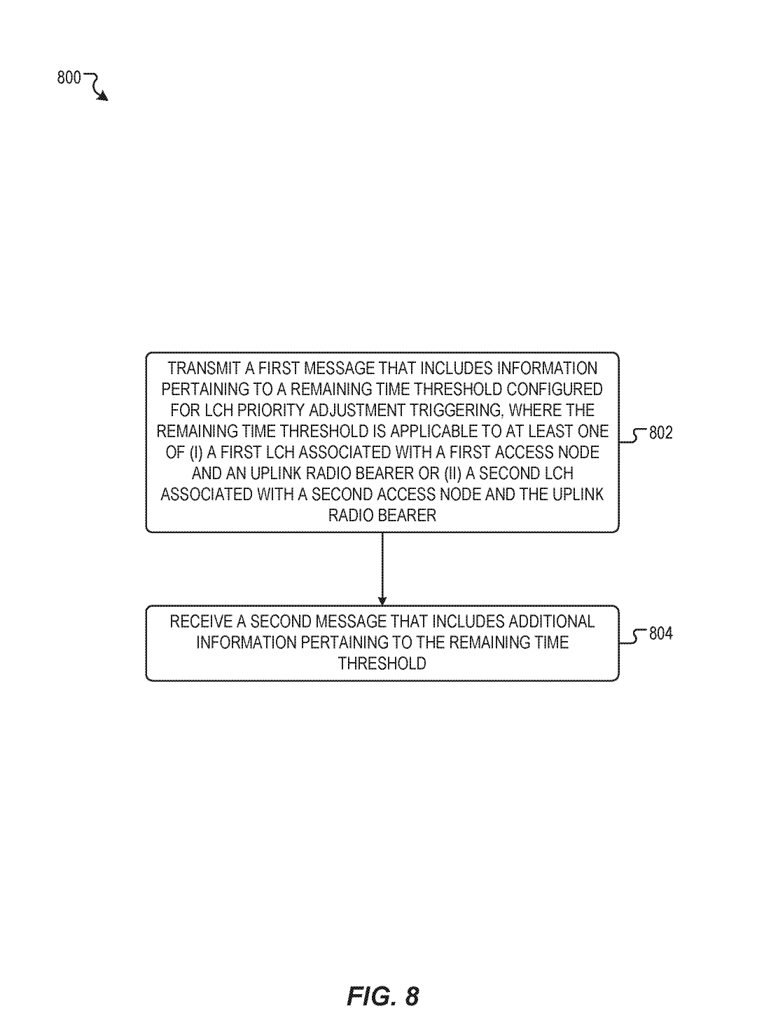

FIG. 8 illustrates a flowchart of an example method 800, according to some implementations. For clarity of presentation, the method 800 is described in the context of the preceding figures. For example, the method 800 can be performed by the base station 104 of FIG. 1, or any suitable system, environment, software, hardware, or combination thereof. Operations of the method 800 can be run in parallel, in combination, in loops, or in any order. The example method 800 shown in FIG. 8 can be modified or reconfigured to include additional, fewer, or different steps (not shown in FIG. 8), which can be performed in the order shown or in a different order.

At 802, the method 800 includes transmitting a first message that includes information pertaining to a remaining time threshold configured for LCH priority adjustment triggering, where the remaining time threshold is applicable to at least one of (i) a first LCH associated with a first access node and an uplink radio bearer or (ii) a second LCH associated with a second access node and the uplink radio bearer.

At 804, the method 800 includes receiving a second message that includes additional information pertaining to the remaining time threshold.

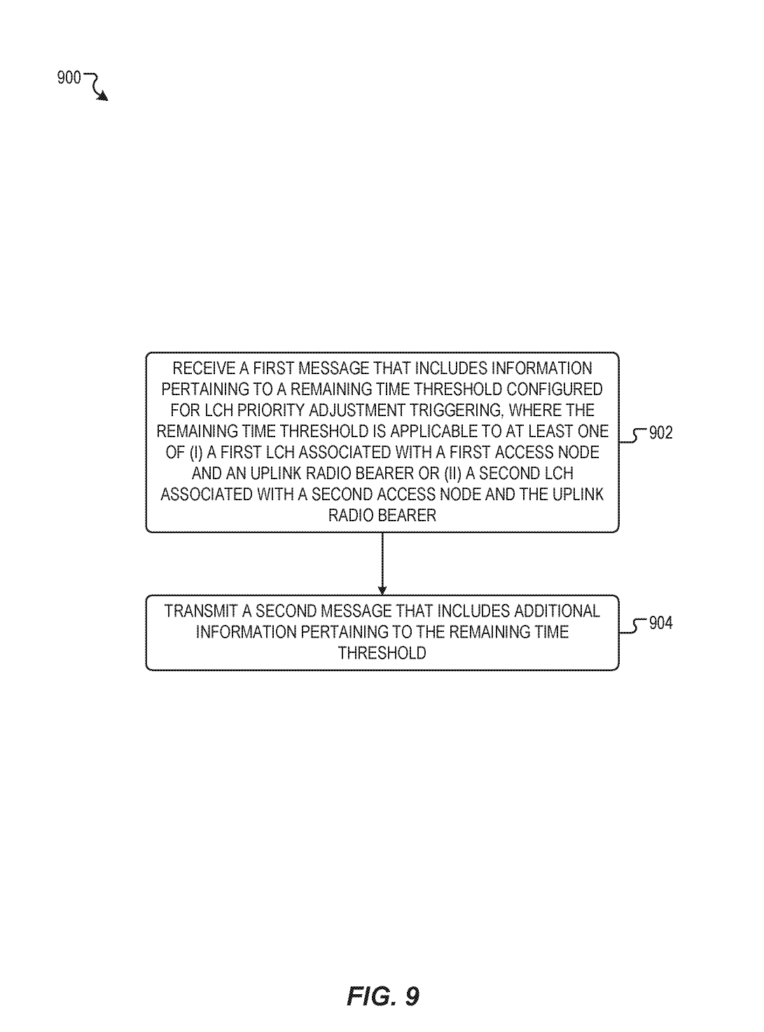

FIG. 9 illustrates a flowchart of an example method 900, according to some implementations. For clarity of presentation, the method 900 is described in the context of the preceding figures. For example, the method 900 can be performed by the base station 104 of FIG. 1, or any suitable system, environment, software, hardware, or combination thereof. In some implementations, operations of the method 900 can be run in parallel, in combination, in loops, or in any order. The example method 900 shown in FIG. 9 can be modified or reconfigured to include additional, fewer, or different steps (not shown in FIG. 9), which can be performed in the order shown or in a different order.

At 902, the method 900 includes receiving a first message that includes information pertaining to a remaining time threshold configured for LCH priority adjustment triggering, where the remaining time threshold is applicable to at least one of (i) a first LCH associated with a first access node and an uplink radio bearer or (ii) a second LCH associated with a second access node and the uplink radio bearer.

At 904, the method 900 includes transmitting a second message that includes additional information pertaining to the remaining time threshold.

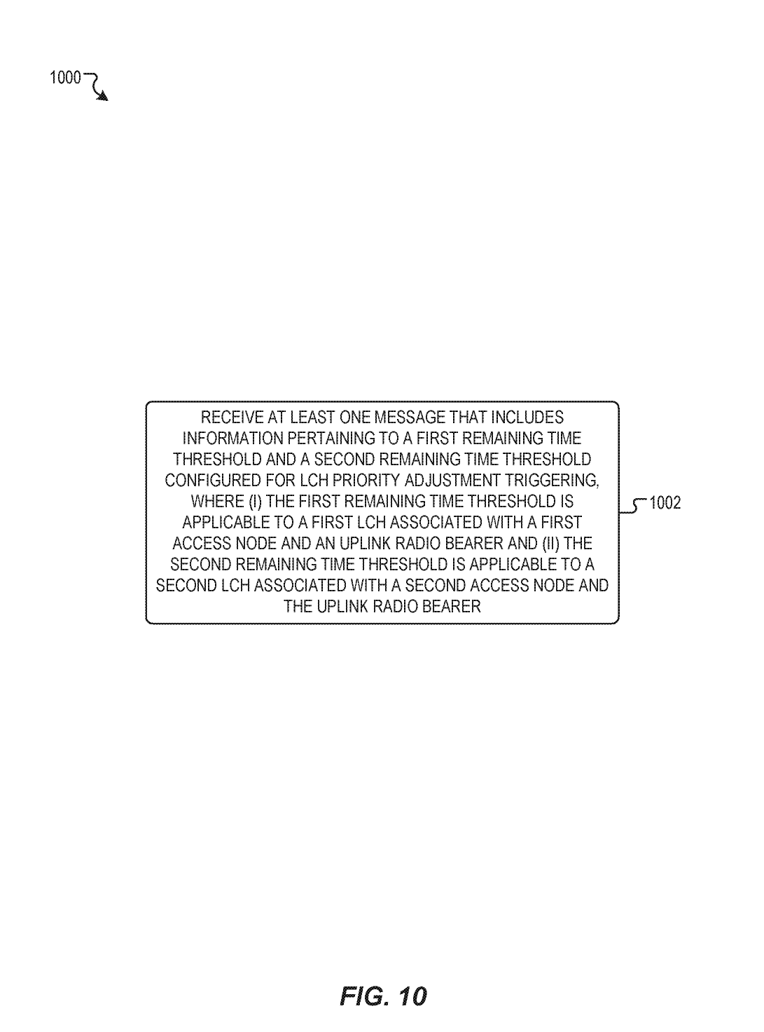

FIG. 10 illustrates a flowchart of an example method 1000, according to some implementations. For clarity of presentation, the method 1000 is described in the context of the preceding figures. For example, the method 1000 can be performed by the UE 102 of FIG. 1, or any suitable system, environment, software, hardware, or combination thereof. In some implementations, operations of the method 1000 can be run in parallel, in combination, in loops, or in any order. The example method 1000 shown in FIG. 10 can be modified or reconfigured to include additional, fewer, or different steps (not shown in FIG. 10), which can be performed in the order shown or in a different order.

At 1002, the method 1000 includes receiving at least one message that includes information pertaining to a first remaining time threshold and a second remaining time threshold configured for LCH priority adjustment triggering, where (i) the first remaining time threshold is applicable to a first LCH associated with a first access node and an uplink radio bearer and (ii) the second remaining time threshold is applicable to a second LCH associated with a second access node and the uplink radio bearer.

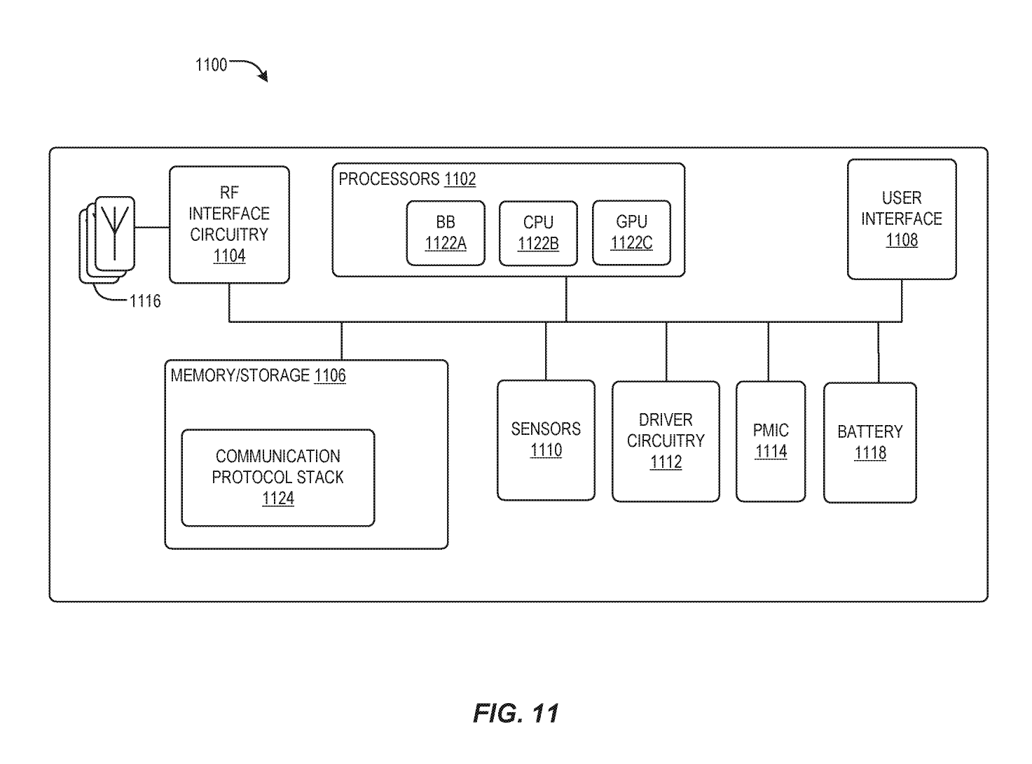

FIG. 11 illustrates an example UE 1100. The UE 1100 may be similar to and substantially interchangeable with UE 102 of FIG. 1. The UE 1100 may include any mobile or non-mobile computing device, such as, for example, a mobile phone, computer, tablet, industrial wireless sensors, video device (for example, cameras, video cameras, and the like), wearable devices (for example, a smart watch), relaxed-IoT devices, etc.

The UE 1100 may include any/all of processor 1102, RF interface circuitry 1104, memory/storage 1106, user interface 1108, sensors 1110, driver circuitry 1112, Power Management Integrated Circuit (PMIC) 1114, one or more antenna(s) 1116, and battery 1118. The components of the UE 1100 may be implemented as Integrated Circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and a different arrangement of the components shown may occur in other implementations.

The components of the UE 1100 may be coupled with various other components over one or more interconnects 1120, which may represent any type of interface, input/output, bus (local, system, or expansion), transmission line, trace, optical connection, etc., that allows various circuit components (on common or different chips or chipsets) to interact with one another.

The processor 1102 may include one or more processors. For example, the processor 1102 may include processor circuitry such as, for example, Baseband (BB) processor circuitry 1122A, Central Processor Unit (CPU) circuitry 1122B, and Graphics Processor Unit (GPU) circuitry 1122C. The processor 1102 may include any type of circuitry or processor circuitry that executes or otherwise operates computer-executable instructions, such as program code, software modules, or functional processes from memory/storage 1106 to cause the UE 1100 to perform operations as described herein.

In some implementations, the baseband processor circuitry 1122A may access a communication protocol stack 1124 in the memory/storage 1106 to communicate over a 3GPP compatible network. In general, the baseband processor circuitry 1122A may access the communication protocol stack to: perform user plane functions at a Physical (PHY) layer, MAC layer, RLC layer, PDCP layer, Service Data Adaptation Protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1104. The baseband processor circuitry 1122A may generate or process baseband signals or waveforms that carry information in 3GPP-compatible networks. In some implementations, waveforms for NR may implement Cyclic Prefix Orthogonal Frequency Division Multiplexing (CP-OFDM) in the uplink or downlink, and Discrete Fourier Transform Spread Orthogonal Frequency Division Multiplexing (DFT-S-OFDM) in the uplink.

The memory/storage 1106 may include one or more non-transitory, computer-readable media that includes instructions (for example, communication protocol stack 1124) that may be executed by the processor 1102 to cause the UE 1100 to perform various operations described herein. The memory/storage 1106 include any type of volatile or non-volatile memory that may be distributed throughout the UE 1100. In some implementations, some of the memory/storage 1106 may be located on the processor 1102 itself (for example, Layer 1 “L1” and Layer 2 “L2” caches), while other memory/storage 1106 is external to the processor 1102 but accessible thereto via a memory interface. The memory/storage 1106 may include any suitable volatile or non-volatile memory such as, but not limited to, Dynamic Random Access Memory (DRAM), Static Random Access Memory (SRAM), Erasable Programmable Read-Only Memory (EPROM), Electrically Erasable Programmable Read-Only Memory (EEPROM), Flash memory, solid-state memory, or any other type of memory device technology.

The RF interface circuitry 1104 may include transceiver circuitry and Radio Frequency Front Module (RFEM) that allows the UE 1100 to communicate with other devices over a radio access network. The RF interface circuitry 1104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1116 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1116. In various implementations, the RF interface circuitry 1104 may be configured to transmit/receive signals in a manner compatible with NR access technologies.

The antenna(s) 1116 may include one or more antenna elements to convert electrical signals into radio waves to travel through the air and to convert received radio waves over the air into electrical signals. In some implementations, the antenna elements may be arranged into one or more antenna panels. The antenna(s) 1116 may have antenna panels that are omnidirectional, directional, or a combination thereof, to enable beamforming and multiple input, multiple output communications. The antenna(s) 1116 may include any/all of microstrip antennas, printed antennas fabricated on the surface of one or more printed circuit boards, patch antennas, phased array antennas, etc. The antenna(s) 1116 may have one or more panels designed for one or more specific frequency bands, such as bands in Frequency Range 1 (FR1) or Frequency Range 2 (FR2).

The user interface 1108 includes various Input/Output (I/O) devices designed to enable user interaction with the UE 1100. The user interface 1108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as Light Emitting Diodes “LEDs” and multi-character visual outputs), or more complex outputs such as display devices or touchscreens (for example, Liquid Crystal Displays “LCDs,” LED displays, quantum dot displays, projectors), with the output of characters, graphics, multimedia objects, and the like being generated or produced from the operation of the UE 1100.

The sensors 1110 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1112 may include software and hardware elements that operate to control particular devices that are embedded in the UE 1100, attached to the UE 1100, or otherwise communicatively coupled with the UE 1100. The driver circuitry 1112 may include individual drivers allowing other components to interact with or control various I/O devices that may be present within, or connected to, the UE 1100. For example, driver circuitry 1112 may include a display driver to control and allow access to a display device, a touchscreen driver to control and allow access to a touchscreen interface, sensor drivers to obtain sensor readings of sensors 1110 and control and allow access to sensors 1110, drivers to obtain actuator positions of electro-mechanic components or control and allow access to the electro-mechanic components, a camera driver to control and allow access to an embedded image capture device, audio drivers to control and allow access to one or more audio devices.

The PMIC 1114 may manage power provided to various components of the UE 1100. In particular, with respect to the processor 1102, the PMIC 1114 may control power-source selection, voltage scaling, battery charging, or Direct Current (DC)-to-DC conversion.

In some implementations, the PMIC 1114 may control, or otherwise be part of, various power saving mechanisms of the UE 1100. A battery 1118 may power the UE 1100, although in some examples the UE 1100 may be mounted deployed in a fixed location, and may have a power supply coupled to an electrical grid. The battery 1118 may be a lithium ion battery, a metal-air battery, such as a zinc-air battery, an aluminum-air battery, a lithium-air battery, and the like. In some implementations, such as in vehicle-based applications, the battery 1118 may be a typical lead-acid automotive battery.

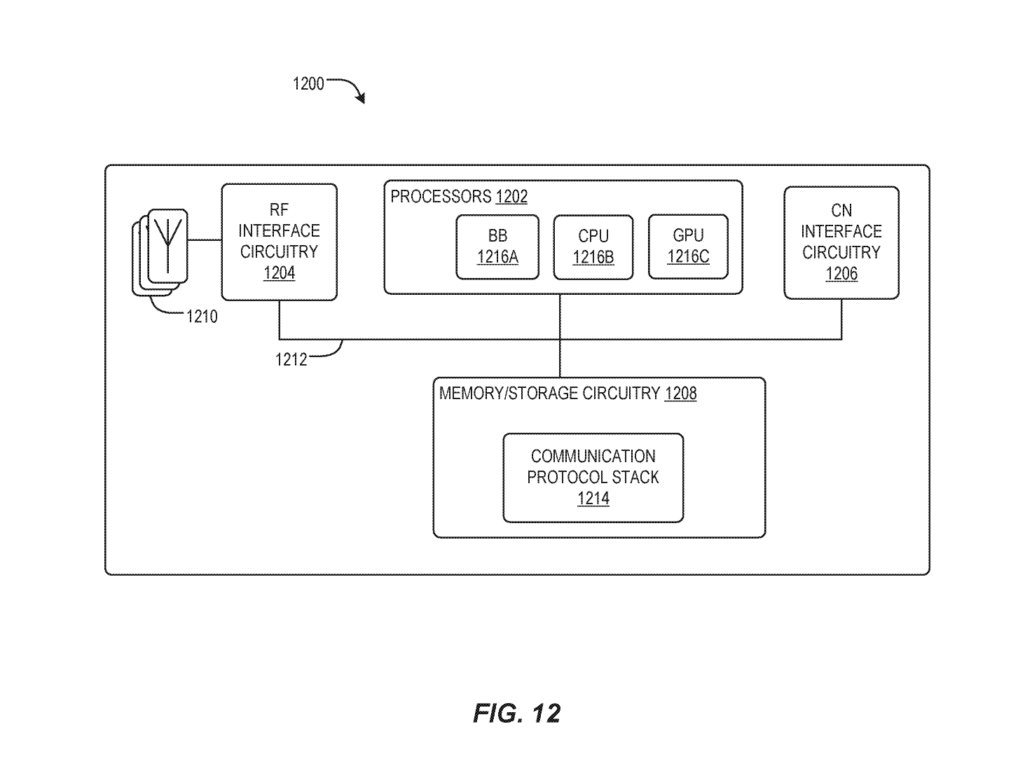

FIG. 12 illustrates an example access node 1200 (e.g., a base station or gNB), according to some implementations. The access node 1200 may be similar to and substantially interchangeable with base station 104. The access node 1200 may include one or more of processor 1202, RF interface circuitry 1204, Core Network (CN) interface circuitry 1206, memory/storage circuitry 1208, and one or more antenna(s) 1210. The processor 1202 may include any type of circuitry or processor circuitry that executes or otherwise operates computer-executable instructions, such as program code, software modules, or functional processes from memory/storage circuitry 1208 to cause the access node 1200 to perform operations as described herein.

The components of the access node 1200 may be coupled with various other components over one or more interconnects 1212. The processor 1202, RF interface circuitry 1204, memory/storage circuitry 1208 (including communication protocol stack 1214), antenna(s) 1210, and interconnects 1212 may be similar to like-named elements shown and described with respect to FIG. 11. For example, the processor 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core (5GC) network using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or Field Programmable Gate Arrays (FPGA) to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as Base Stations (BS), g-Node-Bs (gNB), Radio Access Network (RAN) nodes, e-Node-Bs (eNB), NodeBs, Road Side Units (RSU), Transmit Receive Points (TRP), and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various implementations, the access node 1200 may be implemented as one or more of a dedicated physical device such as a macrocell base station, and/or a Low Power (LP) base station for providing femtocells, picocells or other like cells having smaller coverage areas, smaller user capacity, or higher bandwidth compared to macrocells.

In some implementations, all or parts of the access node 1200 may be implemented as one or more software entities running on server computers as part of a virtual network, which may be referred to as a Cloud Radio Access Network (CRAN) and/or a virtual Baseband Unit Pool (vBBUP). In Vehicle-to-Everything (V2X) scenarios, the access node 1200 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Any of the foregoing examples can be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user’s health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user’s device or other non-personal information available to the content delivery services.

We claim:

1. A method comprising:
receiving at least one message that comprises information pertaining to a first remaining time threshold and a second remaining time threshold configured for logical channel priority adjustment triggering, wherein (i) the first remaining time threshold is applicable to a first logical channel associated with a first access node and an uplink radio bearer and (ii) the second remaining time threshold is applicable to a second logical channel associated with a second access node and the uplink radio bearer; and
submitting, based at least on the information, one or more packets to at least one of a first logical entity associated with the first access node or a second logical entity associated with the second access node.

2. The method of claim 1, wherein submitting the one or more packets to the at least one of the first logical entity or the second logical entity comprises:
submitting the one or more packets to the first logical entity; and
refraining from submitting any packets to the second logical entity, wherein logical channel priority adjustment triggering is activated for the first logical channel and is deactivated for the second logical channel.

3. The method of claim 2, wherein each of the one or more packets has a remaining time value equal to or less than the first remaining time threshold.

4. The method of claim 1, wherein submitting the one or more packets to the at least one of the first logical entity or the second logical entity comprises:
applying a special data volume threshold to determine whether packet submission to the first logical entity is allowed; and
submitting, based on the special data volume threshold being satisfied, the one or more packets to the first and second logical entities, wherein:
logical channel priority adjustment triggering is activated for the first logical channel and is deactivated for the second logical channel,
the at least one message indicates the special data volume threshold, and
the special data volume threshold is smaller than a default uplink data split threshold.

5. The method of claim 1, wherein submitting the one or more packets to the at least one of the first logical entity or the second logical entity comprises:
determining that a total data volume is larger than a default uplink data split threshold; and
submitting the one or more packets to the first and second logical entities based at least on a data volume split ratio, wherein:
logical channel priority adjustment triggering is activated for the first logical channel and is deactivated for the second logical channel,
the at least one message indicates the data volume split ratio, and
the data volume split ratio represents a ratio of distributed packet volume between the first logical entity and the second logical entity.

6. The method of claim 1, wherein the at least one message comprises a dynamic indication to change the first remaining time threshold configured for the first logical channel or the second remaining time threshold configured for the second logical channel, and
wherein the dynamic indication comprises an identifier of the first logical channel or the second logical channel, and a value to use for the first remaining time threshold or the second remaining time threshold.

7. The method of claim 6, wherein the value of the first remaining time threshold or the second remaining time threshold is selected from a plurality of remaining time threshold values configured for the first logical channel or the second logical channel.

8. The method of claim 6, further comprising:
disabling priority adjustment for the first logical channel based at least in part on the value of the first remaining time threshold representing a disablement of priority adjustment for the first logical channel, or
disabling priority adjustment for the second logical channel based at least in part on the value of the second remaining time threshold representing a disablement of priority adjustment for the second logical channel.

9. The method of claim 1, wherein the first remaining time threshold is different from the second remaining time threshold.

10. The method of claim 1, further comprising:
triggering priority adjustment for at least one of the first logical channel or the second logical channel based on at least one of:
(i) a lowest remaining time threshold configured for the first logical channel or the second logical channel,
(ii) a highest remaining time threshold configured for the first logical channel or the second logical channel,
(iii) the first remaining time threshold configured for the first logical channel, or (iv) the second remaining time threshold configured for the second logical channel.

11. The method of claim 1, further comprising:
receiving a dynamic instruction to switch the first remaining time threshold.

12. The method of claim 11, further comprising:
in response to receiving the dynamic instruction, switching the first remaining time threshold.

13. The method of claim 1, further comprising:
receiving a dynamic instruction to activate or deactivate logical channel priority adjustment for the uplink radio bearer associated with the first logical channel and the second logical channel.

14. The method of claim 13, further comprising:
based on determining that the dynamic instruction is received from the first access node, activating or deactivating logical channel priority adjustment for the first logical channel, or
based on determining that the dynamic instruction is not received from the second access node, activating or deactivating logical channel priority adjustment for the second logical channel.

15. The method of claim 13, further comprising:
in response to receiving the dynamic instruction from at least one of the first access node or the second access node, activating or deactivating logical channel priority adjustment for both the first logical channel and the second logical channel of the uplink radio bearer.

16. A baseband processor configured to, when executing instructions stored in a memory, perform operations, the operations comprising:
identifying at least one message that comprises information pertaining to a first remaining time threshold and a second remaining time threshold configured for logical channel priority adjustment triggering, wherein (i) the first remaining time threshold is applicable to a first logical channel associated with a first access node and an uplink radio bearer and (ii) the second remaining time threshold is applicable to a second logical channel associated with a second access node and the uplink radio bearer; and
causing, based at least on the information, a submission of one or more packets to at least one of a first logical entity associated with the first access node or a second logical entity associated with the second access node.

17. The baseband processor of claim 16, wherein causing the submission of the one or more packets to the at least one of the first logical entity or the second logical entity comprises:
causing the submission of the one or more packets to the first logical entity; and
refraining from submitting any packets to the second logical entity, wherein logical channel priority adjustment triggering is activated for the first logical channel and is deactivated for the second logical channel.

18. The baseband processor of claim 17, wherein each of the one or more packets has a remaining time value equal to or less than the first remaining time threshold.

19. The baseband processor of claim 16, wherein causing the submission of the one or more packets to the at least one of the first logical entity or the second logical entity comprises:
applying a special data volume threshold to determine whether packet submission to the first logical entity is allowed; and
causing, based on the special data volume threshold being satisfied, the submission of the one or more packets to the first and second logical entities, wherein:
logical channel priority adjustment triggering is activated for the first logical channel and is deactivated for the second logical channel,
the at least one message indicates the special data volume threshold, and
the special data volume threshold is smaller than a default uplink data split threshold.

20. The baseband processor of claim 16, wherein causing the submission of the one or more packets to the at least one of the first logical entity or the second logical entity comprises:
determining that a total data volume is larger than a default uplink data split threshold; and
causing the submission of the one or more packets to the first and second logical entities based at least on a data volume split ratio, wherein:
logical channel priority adjustment triggering is activated for the first logical channel and is deactivated for the second logical channel,
the at least one message indicates the data volume split ratio, and
the data volume split ratio represents a ratio of distributed packet volume between the first logical entity and the second logical entity.
